(19) United States
(12) Patent Application Publication
(10) Pub. No.: US 2004/0218043 A1
(43) Pub. Date: Nov. 4, 2004

(54) Memory module

(75) Inventor: Stephen Lee Robinson, Fresno, CA (US)

Correspondence Address: GUNSTER, YOAKLEY & STEWART, PA, BROWARD FINANCIAL CENTRE, SUITE 1400, 500 EAST BROWARD BLVD, FT LAUDERDALE, FL, 33394, US

(73) Assignee: Pelco

(21) Appl. No.: 09/896,027

(22) Filed: Jun. 29, 2001

(51) Int. Cl. H04N 7/18

(52) U.S. Cl. 348/151

(57) ABSTRACT

The present invention provides an electronic memory module that retains information that is specific to physical location of a piece of surveillance equipment which can be used by any equipment that is deployed at that location. The memory module of the present invention is kept at the same physical location in order that it may be attached to and used by whatever surveillance equipment is subsequently placed there.

### BACKGROUND OF THE INVENTION

1. Field of the Invention

The present invention relates generally to storage and retrieval of information, and more particularly to an electronic memory module for use with a video surveillance camera system that stores information regarding a particular physical location.

2. Description of the Prior Art

In the closed circuit television (CCTV) industry, it is typical for a number of surveillance cameras to be deployed at various locations throughout a building such as a bank, retail store or casino. Each such camera must be programmed according to its specific physical location. For example, a surveillance camera that is stationed in the ceiling above an aisle in a department store will likely be programmed to scan up and down the aisle, perhaps zooming in at each end of the aisle; whereas, a wall-mounted camera overlooking a bank teller will likely be programmed to zoom in and remain focused only on a specific area around the teller's window. These examples are illustrative of the countless different specific camera programming requirements that are dictated by the particular physical location of the camera.

In large buildings or large surveillance areas, dozens if not hundreds of video surveillance camera stations may be established. In many cases, surveillance cameras are not deployed at every station at all times. Instead, in order to save costs, a user will purchase considerably fewer cameras than stations, and move the cameras from one station to another on a rotational basis. Thus, at any given time a ceiling, wall or otherwise mounted camera dome may or may not actually contain a surveillance camera.

The result of moving surveillance cameras from one location to another, or from exchanging out a non-functional camera for repair or maintenance, is that the newly deployed camera must be reprogrammed for the new physical location. This can be a tedious and time-consuming process that must be endured every time the cameras are rotated or moved to different locations.

It is therefore desirable to provide a way of maintaining programming for a video surveillance camera that is specific to a given physical location such that the programming can be easily transferred to any camera deployed at that location.

### SUMMARY OF THE INVENTION

The present invention provides an electronic memory module that retains information that is specific to physical location of a piece of surveillance equipment which can be used by any equipment that is deployed at that location. The memory module of the present invention is kept at the same physical location in order that it may be attached to and used by whatever surveillance equipment is subsequently placed there. Information retained in the memory module typically includes, but is not limited to, preset locations (angle, azimuth, zoom, focus, and iris for a particular viewing direction), pan and tilt patterns, zones and zone labels, zooming in or out, focus or iris functions, camera title (location, name, number, etc.) and any other information that is unique to the particular physical location.

The memory module of the present invention is designed to be permanently attached to the camera housing (back box) that is installed at a specific physical location, and easily coupled with whatever surveillance equipment (e.g. a camera) is deployed at the physical location. Importantly, the memory module of the present invention has a universal format with respect to both programming and plug compatibility. This allows the module to be used with a variety of different types of physical equipment. In this way, a number of different cameras or other equipment can be swapped into or out of the physical location without having to reprogram location specific information.

In use, the memory module of the present invention is provided with location specific programming information. This can be done at the physical location, or from a central computer used to program memory modules used in the system. The memory module is then deployed at the physical location (i.e., attached to the back box for the camera) where it remains. A camera or other surveillance equipment is then installed at the physical location and connected to the memory module. Upon the application of power, the camera may be programmed to check its internal memory against the memory in the attached module. In some instances, it may not be desirable for the camera to download information from the module, and so the camera will either retain any previous information or have a blank memory ready for programming. However, in most cases, the comparison step will take place. If the two memories are different, the camera will then download the location-specific information from the attached module. In this manner, the “new” (newly-installed) camera will be automatically programmed for the pre-set locations, patterns, zones, etc. that are unique to the particular camera housing and its physical location.

Should the camera at the location receive new information from an operator (e.g. in the camera monitor room), this updated information is passed along to the attached memory module in the particular camera housing for that particular camera location. This is accomplished using non-volatile memory in the module (such as without limitation EPROM, Flash, battery backed up RAM, FRAM, and the like) that may be updated, but does not require continuous application of power to maintain information stored in memory. This allows the memory module to maintain the most up to date programming information for the physical location with or without power.

It is therefore a primary object of the present invention to provide a programmable module for storing location-specific information, the module being designed to be installed at a particular physical location and connected to whatever surveillance equipment is deployed at the location so that the location-specific information in the module may be downloaded to the surveillance equipment for use.

It is also a primary object of the present invention to provide a universal memory module that can be attached to any of a number of different pieces of surveillance equipment in order to provide such equipment with physical location-specific information for use by the equipment in surveillance operations.

It is another object of the present invention to provide a method and apparatus for storing location-specific information at a physical location so that such information may be used by any surveillance equipment that is deployed at that location.

It is another object of the present invention to provide a method and apparatus for allowing different pieces of surveillance equipment that are swapped into and out of a particular physical location to obtain location-specific information from that location for use in surveillance operations.

It is another object of the present invention to provide a method and apparatus for storing location-specific information at a physical location so that it may be accessed and used by any piece of surveillance equipment that is deployed at the location.

Additional objects of the invention will be apparent from the detailed descriptions and the claims herein.

### BRIEF DESCRIPTION OF THE DRAWINGS

FIG. 1 is a cut-away side view of a physical location showing a typical implementation of the memory module of the present invention.

FIG. 2 is an illustration of a physical location for a surveillance camera requiring location specific programming information.

FIG. 3 is a flow chart of the steps of operation using the present invention.

### DETAILED DESCRIPTION OF THE PREFERRED EMBODIMENTS

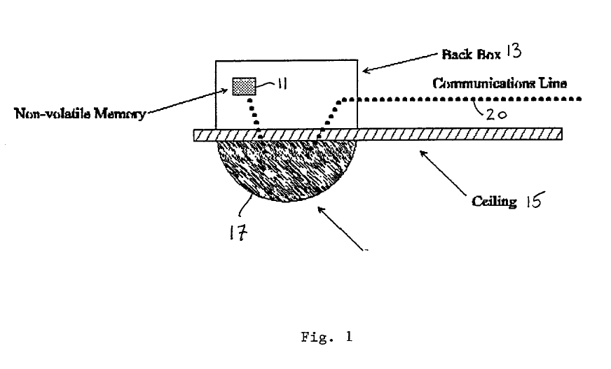

Referring to the drawings wherein like reference characters designate like or corresponding parts throughout the several views, and referring particularly to the diagram of FIG. 1, it is seen that a video surveillance station is established in a ceiling 15 by cutting an opening in the ceiling, and installing a housing (back box) 13 above the opening. The back box becomes a permanent fixture on the ceiling. A dome 17 or other covering may or may not be installed below the ceiling and back box, depending on whether the surveillance equipment deployed there is to be hidden or not. Communications and power lines 20 are connected to the back box 13 leading back to a central monitoring operation.

The surveillance station will have its own location-specific information and criteria that will affect the activity and operation of the surveillance equipment that is deployed there. For example, and by way of illustration only, the station may be established above an intersection of two walking isles below, in which case the surveillance equipment would likely be required to scan in a plus-shaped (+) pattern in order to make observations up and down both of the isles. This kind of location-specific information is stored in a module 11 that is attached to the back box 13. Module 11 contains a bank of non-volatile memory that is designed for permanent attachment to back box 13. The location-specific information may be programmed into module 11 before it is installed onto back box 13, or it may be programmed at the location after installation. The non-volatile memory allows the information to be updated in the event any changes are to be made to the programming. For example, and by way of illustration only, if from the above example the layout below the station is changed such that one of the isles is eliminated, then the scanning pattern may be changed from the plus-shape (+) to some other appropriate pattern.

A camera 21 or other piece of surveillance equipment (not shown) may be removably deployed at the location, together with electronics, one or more motors, a mounting base, and other components to be used by the camera at the station. This deployment includes connecting power and communications lines 20 to the camera electronics, and also includes connecting module 11 to the camera electronics. Then, when camera 21 is powered up, it is programmed to compare its internal memory to that in module 11. If the information in the two memories is different, the camera automatically downloads the information in the memory of module 11 into its own memory, thereby obtaining the necessary location-specific information needed for proper operation at that location. As control information (presets, patterns, etc.) comes into the camera from the remote operations station via the communication line, the information in the non-volatile memory of module 11 is updated. When the camera 21 and related equipment are removed from the back box 13, the module 11 stays behind at the physical location. Then, when new camera equipment is deployed at the station, it is connected to the module 11 and checks for site specific information and, if required, downloads if from the non-volatile memory of the module before beginning operations.

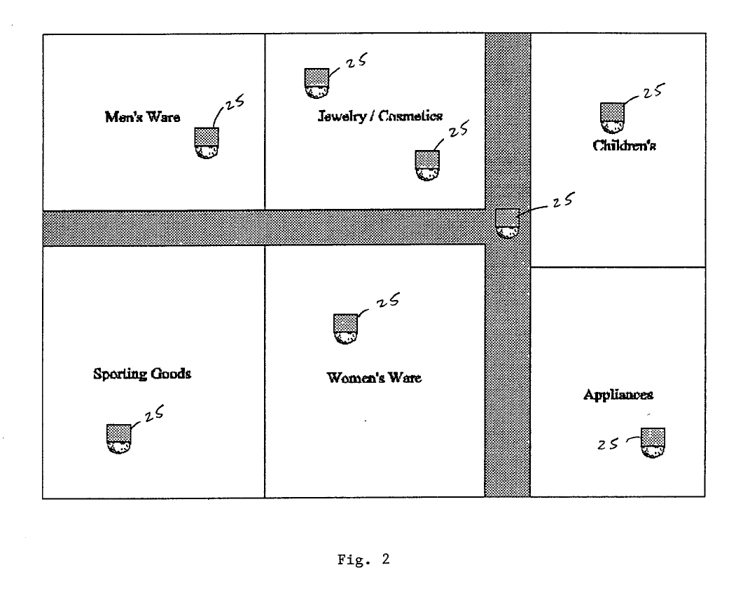

Referring to the retail floor of FIG. 2, it is seen that eight surveillance stations 25 have been established; however, for illustrative purposes only, only three cameras 21 are to be deployed. Each station 25 includes a back box 13 having its own memory module 11 installed there containing site specific information. The cameras may be deployed in any three of the eight stations, and may be rotated from one location to another according to the desires of the user. It is apparent that the angles, azimuth, zoom, focus, iris, pattern, presets and other information needed to efficiently operate a camera will vary from location to location. The site that monitors the appliances area, for example, will have different operating characteristics and requirements from the site that monitors men's ware. In addition, the locations of cash registers, jewelry counters and other priority locations may change from time to time, thereby requiring changes to the site-specific information in the modules 11 associated with those locations.

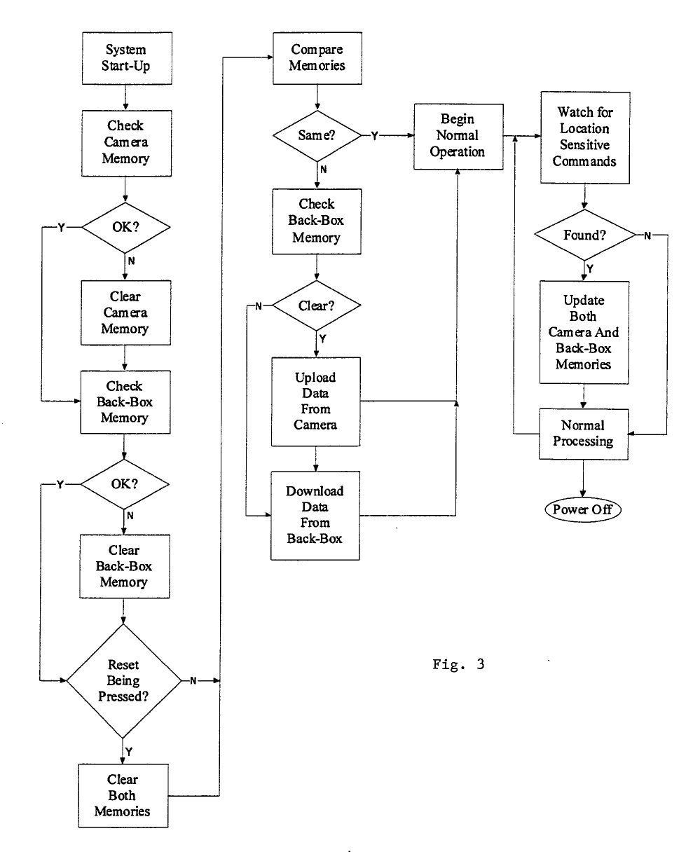

FIG. 3 illustrates the steps of operation of the present invention. First, the memory module 11 of the present invention is programmed and installed onto a back box 13 at a physical location. Then a camera 21 or other equipment is installed in the back box, and connected to module 11. In those situations where the information in the module memory is not to be used, the camera or other equipment may simply not be connected to the module. Once connected, when power is applied, the camera performs a self-check of its memory and then the memory in the module attached to the back box. If either memory is bad or if a reset command is given, then the affected memory is cleared. Otherwise, the information in the memory in the camera is compared to that in the module. If they are the same, normal processing begins. Otherwise, the memory in the module is checked to determine if it is empty. If so, information may be uploaded to the module from the camera. If not, then the information in the module memory is downloaded to the camera. Normal operation of the camera then begins. The camera may receive location sensitive commands or changes to the location information. When this occurs, both the camera and module memories are updated to reflect the changes. By the use of non-volatile memory in the module, any such changes are retained at power off to be used by the next camera or piece of surveillance equipment used at the location.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. An apparatus for storing location-specific information for use with surveillance equipment deployed at a physical location comprising:
a. a housing for supporting surveillance equipment to be deployed at the location;
b. an module containing non-volatile memory mounted on said housing;
c. a first electronic connection on said housing in communication with a central control; and
d. a second electronic connection on said module for connecting said module to surveillance equipment deployed at the location.

2. The apparatus of claim 1 wherein said module is electronically programmable, and location-specific information may be stored in the non-volatile memory therein.

3. The apparatus of claim 2 wherein a piece of surveillance equipment is mounted onto said housing and connected to both said first and second electronic connections.

4. The apparatus of claim 3 wherein said surveillance equipment is a video camera.

5. The apparatus of claim 3 wherein said surveillance equipment has an internal memory and wherein upon power up said surveillance equipment loads the information from the memory of said module into its internal memory.

6. The apparatus of claim 3 wherein said surveillance equipment has an internal memory and wherein upon power up said surveillance equipment compares the information in its internal memory with the information in the memory of said module, and if the information is different, said equipment loads the information from the memory of said module into its internal memory.

7. The apparatus of claim 6 wherein information is provided to said surveillance equipment and said module through said first electronic connection and the memory in both said equipment and said module is updated with said information.

8. A method for providing location-specific information for use with surveillance equipment deployed at a physical location comprising the steps of:
a. installing a housing for supporting surveillance equipment at the location;
b. attaching a module containing non-volatile memory to said housing;
c. loading location-specific information into the memory of said module;
d. deploying a piece of electronic surveillance equipment having a memory into said housing including connecting said equipment to a first electronic connection on said housing in communication with a central control, and connecting said equipment to a second electronic connection in communication with said module;
e. applying power to said equipment and to said module; and
f. loading the information from the memory of said module into the memory of said equipment.

9. The method of claim 8 wherein step “f” is replaced with the steps of:
f. comparing the information in the memory of said module with the information in the memory of said equipment; and
g. if said information is different, loading the information from the memory of said module into the memory of said equipment.

10. The method of claim 8 wherein step “c” is omitted, and step “f” is replaced with the step of loading information from the memory of said equipment into the memory of said module.

11. The method of claim 9 including the additional steps of:
h. monitoring for information from said central control; and
i. updating the memory in both said equipment and said module according to any information received from said central control.

12. A memory module for use with a video surveillance camera mounted on a pan and tilt mechanism to retain camera operation information specific to the pan and tilt mechanism comprising:
a. a non-volatile memory circuit for retaining the camera operation information;
b. a memory output circuit for outputting the camera operation information
c. a memory input circuit for inputting camera control information from a remote location into the memory circuit; and
d. a camera operation circuit for operating various parameters of the camera in response to camera control information from the memory output circuit.

13. The module of claim 12 wherein a camera control information comparing circuit is provided for comparing information received from the camera with information from the memory circuit, and replacing said information in said camera, if different.

14. The module of claim 12 wherein a camera control information comparing circuit is provided for comparing information received from the camera with information from the memory circuit, and replacing the information in said memory circuit, if different.

15. The module of claim 12 wherein a monitoring circuit is provided for determining whether new information is available on said memory input circuit, and if present loading such new information into the memory circuit.
